(19) United States
(12) Patent Application Publication
(10) Pub. No.: US 2024/0429823 A1
(43) Pub. Date: Dec. 26, 2024

(54) CONVERTER CIRCUIT AND CONTROL METHOD THEREOF

(71) Applicant: Samsung Electronics Co., Ltd., Suwon-si (KR)

(72) Inventors: Jungwoo YANG, Suwon-si (KR); Jeongil KANG, Suwon-si (KR); Moonyoung KIM, Suwon-si (KR); Sungyong JOO, Suwon-si (KR)

(21) Appl. No.: 18/824,244

(22) Filed: Sep. 4, 2024

Related U.S. Application Data
(63) Continuation of application No. PCT/KR2023/004164, filed on Mar. 29, 2023.

(30) Foreign Application Priority Data
May 23, 2022 (KR) 10-2022-0063089
Jul. 6, 2022 (KR) 10-2022-0083399

(51) Int. Cl. H02M 3/158; H02M 1/00; H02M 1/42

(52) U.S. Cl. CPC H02M 3/158; H02M 1/0043; H02M 1/4208

(57) ABSTRACT

A converter circuit according to an aspect of the disclosure may comprise: first, second, third and fourth inductors which are connected in parallel to each other; first, second, third and fourth switching elements comprising at least one switch connected to the first, second, third and fourth inductors respectively; and at least one processor, comprising processing circuitry, individually and/or collectively, configured to control the first, second, third and fourth switching elements, wherein the first inductor and the second inductors are coupled to each other, and the third inductor and fourth inductor are coupled each other.

### CROSS-REFERENCE TO RELATED APPLICATIONS

This application is a continuation of International Application No. PCT/KR2023/004164 designating the United States, filed on Mar. 29, 2023, in the Korean Intellectual Property Receiving Office and claiming priority to Korean Patent Application Nos. 10-2022-0063089, filed on May 23, 2022, and 10-2022-0083399, filed on Jul. 6, 2022, in the Korean Intellectual Property Office, the disclosures of each of which are incorporated by reference herein in their entireties.

### BACKGROUND

### Field

The disclosure relates to a converter circuit including an inductor and a control method thereof.

### Description of Related Art

A circuit structure generally applied to a power circuit of 75 W or more is composed of PFC converter that converts AC input commercial power to DC voltage and has a power factor correction (PFC) improvement function, and LLC converter in which DC output voltage of PFC converter is output as rated DC voltage.

A conventional PFC converter generally operates in critical conduction mode (CrM) in which an operating frequency changes depending on a phase of an input AC voltage and a load. When the output load specification increases in the single-phase PFC converter structure, there is a limit to single-channel operation, and thus an inductor, a switch, and a diode are added in the single-phase PFC converter and then divided into two phases. A gate signal of each phase operates with a 180-degree phase shift, and thus efficiency may be improved and heat source may be distributed. In addition, when a load decreases, the increase in operating frequency may be suppressed by deactivating one phase, thereby improving light load efficiency. At this time, switches are used in parallel for heat dissipation and price competitiveness of the switch, and in the case of diodes, a single package diode composed of two diodes in one package is applied.

A conventional interleaved PFC converter has a fixed inductance value as the input voltage increases or the load decreases, and thus an operating frequency increases as the load decreases and the input voltage increases. This increase in operating frequency causes an increase in the switching loss of the switch (proportional to the operating frequency) and the core loss of the magnetic element (proportional to the operating frequency\hat{ }n), which has a significant impact on reducing overall efficiency.

### SUMMARY

Embodiments of the disclosure provide a converter circuit capable of applying a coupled inductor to each phase inductor of an interleaved converter and dividing switch operation modes according to an input voltage and a load, and capable of, when the input voltage is increased or the load is reduced, reducing an operating frequency by increasing an inductance value of the inductor, thereby improving efficiency, and a control method thereof.

According to an example embodiment of the disclosure, a converter circuit may include: first, second, third and fourth inductors connected in parallel to each other; first, second, third and fourth switching elements, comprising a switch, connected to the first, second, third and fourth inductors respectively; and at least one processor, comprising processing circuitry, individually and/or collectively, configured to control the first, second, third and fourth switching elements. The first inductor and the second inductors are coupled to each other, and the third inductor and fourth inductor are coupled each other.

At least one processor, individually and/or collectively, may be configured to turn on at least one switching element among the first, second, third and fourth switching elements based on an input voltage and a load.

At least one processor, individually and/or collectively, may be configured to turn on one switching element among the first, second, third and fourth switching elements in response to the input voltage being less than a specified voltage and in response to the load being less than a specified load.

At least one processor, individually and/or collectively, may be configured to turn on one of the first and second switching elements and configured to turn on one of the third and fourth switching elements in response to the input voltage being greater than the specified voltage and in response to the load being greater than the specified load.

At least one processor, individually and/or collectively, may be configured to turn on one switching element among the first, second, third and fourth switching elements in response to the input voltage being greater than the specified voltage and in response to the load being less than the specified load.

The coupled inductor may include at least one of a UU core inductor, an EE core inductor, or an EI core inductor.

The first, second, third and fourth switching elements may include transistors, gate voltages output from the first switching element and the second switching element may have opposite phases to each other, and gate voltages output from the third and fourth switching elements may have opposite phases to each other.

The converter circuit may further include first, second, third and fourth diodes connected in series with the first, second, third and fourth inductors, respectively. The first diode, the second diode, the third diode, and the fourth diode may be each integrated into one package.

The coupled inductor may be coupled to allow a polarity of an induced voltage to be the same or to be opposite.

The coupled inductor may be formed to allow each current to flow in a direction in which a magnetic flux is canceled out.

According to an example embodiment of the disclosure a method of controlling a converter circuit including: first, second, third and fourth inductors connected in parallel to each other; and first, second, third and fourth switching elements comprising a switch connected to the first, second, third and fourth inductors respectively, the method including: detecting an input voltage and a load; and controlling the first, second, third and fourth switching elements based on the detected input voltage and load. The first inductor and the second inductors are coupled to each other, and the third inductor and fourth inductor are coupled each other.

The controlling of the first, second, third and fourth switching elements may include turning on at least one switching element among the first, second, third and fourth switching elements based on the detected input voltage and load.

The controlling of the first, second, third and fourth switching elements may include turning on one switching element among the first, second, third and fourth switching elements in response to the input voltage being less than a specified voltage and in response to the load being less than a specified load.

The controlling of the first, second, third and fourth switching elements may include turning on one of the first and second switching elements and turning on one of the third and fourth switching elements in response to the input voltage being greater than the specified voltage and in response to the load being greater than the specified load.

The controlling of the first, second, third and fourth switching elements may include turning on one switching element among the first, second, third and fourth switching elements in response to the input voltage being greater than the specified voltage and in response to the load being less than the specified load.

The coupled inductor may include at least one of a UU core inductor, an EE core inductor, or an EI core inductor.

The first, second, third and fourth switching elements may include transistors, gate voltages output from the first switching element and the second switching element may have opposite phases to each other, and gate voltages output from the third and fourth switching elements may have opposite phases to each other.

The converter circuit may further include first, second, third and fourth diodes connected in series with the first, second, third and fourth inductors, respectively. The first diode, the second diode, the third diode, and the fourth diode may be each integrated into one package.

The coupled inductor may be coupled to allow a polarity of an induced voltage to be the same or to be opposite.

The coupled inductor may be formed to allow each current to flow in a direction in which a magnetic flux is canceled out.

A coupled inductor is applied to each phase inductor of an interleaved converter, and switch operation modes are divided according to an input voltage and a load, and thus when the input voltage is increased or the load is reduced, an operating frequency may be reduced by increasing an inductance value of the inductor. Accordingly, efficiency may be improved.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a circuit diagram illustrating an example structure of a converter circuit according to various embodiments;

FIG. 2 is a diagram illustrating an example structure of a coupled inductor according to various embodiments;

FIG. 3 is a diagram illustrating an equivalent inductance of the coupled inductor according to FIG. 2 according to various embodiments;

FIG. 4 is a circuit diagram illustrating an example structure of a converter circuit including the equivalent inductance of FIG. 3 according to various embodiments;

FIG. 5 is a block diagram illustrating an example configuration of the converter circuit according to various embodiments;

FIG. 6 is a circuit diagram illustrating a state in which all switches are turned on according to various embodiments;

FIG. 7 is a circuit diagram illustrating a state in which one switch is turned on according to various embodiments;

FIGS. 8A and 8B are graphs illustrating the decrease in frequency according to the switching of FIG. 7 according to various embodiments;

FIG. 9 is a circuit diagram illustrating a state in which two switches are turned on according to various embodiments;

FIGS. 10A and 10B are graphs illustrating the decrease in frequency according to the switching of FIG. 9 according to various embodiments;

FIG. 11 is a circuit diagram illustrating a state in which one switch is turned on according to various embodiments;

FIGS. 12A and 12B are graphs illustrating the decrease in frequency according to the switching of FIG. 11 according to various embodiments;

FIG. 13 includes graphs illustrating efficiency according to voltage and load according to various embodiments;

FIG. 14 is a diagram illustrating an example structure of a coupled inductor according to various embodiments;

FIG. 15 is a circuit diagram illustrating an example structure of a converter circuit including an equivalent inductance of the coupled inductor according to FIG. 14 according to various embodiments;

FIG. 16 is a flowchart illustrating an example method of controlling a converter circuit according to various embodiments; and

FIG. 17 is a flowchart illustrating an example method of controlling the converter circuit according to various embodiments.

### DETAILED DESCRIPTION

Embodiments described in the disclosure and configurations shown in the drawings are merely examples of various example embodiments of the disclosure, and may be modified in various different ways at the time of filing of the disclosure.

In addition, the same reference numerals or signs shown in the drawings of the disclosure indicate elements or components performing substantially the same function.

The terms used herein are used to describe various embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

It will be understood that when an element is referred to as being “connected” or “coupled” to another element, it can be directly or indirectly connected or coupled to the other element.

It will be understood that, although the terms first, second, third, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

The disclosure will be described more fully hereinafter with reference to the accompanying drawings.

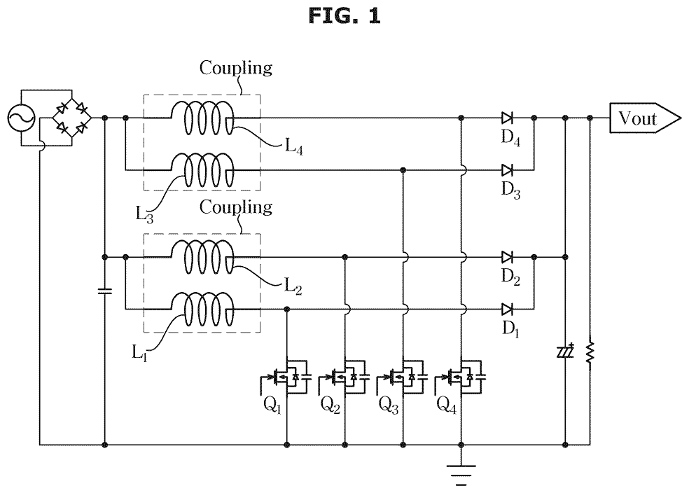

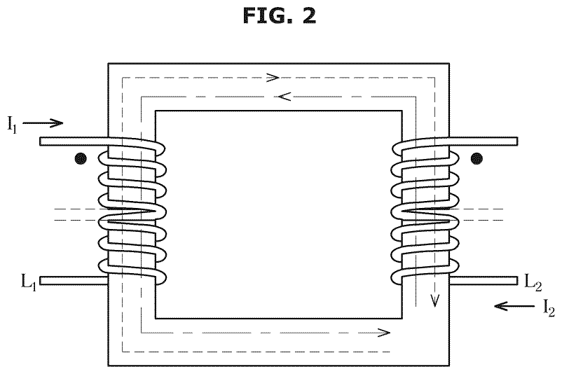

FIG. 1 is a circuit diagram illustrating an example structure of a converter circuit according to various embodiments, and FIG. 2 is a diagram illustrating an example structure of a coupled inductor according to various embodiments.

Referring to FIG. 1, a converter circuit according to an embodiment may include first to fourth inductors L1-L4 (L1, L2, L3, L4) connected in parallel with each other, first to fourth switching elements Q1-Q4 (Q1, Q2, Q3, Q4) connected to the first to fourth inductors L1-L4, respectively, and first to fourth diodes D1-D4 (D1, D2, D3, D4) connected in series with the first to fourth inductors L1-L4, respectively.

The first inductor L1 and the second inductor L2 may be coupled to each other, and the third inductor L3 and the fourth inductor L4 may be coupled to each other. A description of each coupled inductor will be described in greater detail below.

The first to fourth switching elements Q1-Q4 may be formed of transistors. Gate voltages output from the first switching element Q1 and the second switching element Q2 may have opposite phases to each other, and gate voltages output from the third switching element Q3 and the fourth switching element Q4 may have opposite phases to each other.

As mentioned above, the gate voltage output from the switching element of each phase may operate with a 180-degree phase shift, thereby improving efficiency and dispersing the heat source.

Further, the first diode D1, the second diode D2, the third diode D3, and the fourth diode D4 may each integrated into one package.

Referring to FIG. 2, the coupled inductor may be formed as a UU core inductor. However, the present disclosure is not limited thereto, and the coupled inductor may be formed as at least one of an EE core inductor or an EI core inductor.

Coupled inductor may refer, for example, to two different inductors that are magnetically coupled to each other so that energy is transmitted and received through a magnetic field.

According to the present disclosure, the first inductor L1 and the second inductor L2 adjacent to each other may be coupled to each other, and the third inductor L3 and the fourth inductor L4 adjacent to each other may be coupled to each other.

Each coupled inductor may be formed to allow each current I1 and I2 flows in a direction in which a magnetic flux is canceled out.

Referring to FIG. 2, in the first inductor located on the left, the current I1 may flow to allow a magnetic field to be formed in the clockwise direction of the core, and in the second inductor located on the right, the current I2 may flow to allow a magnetic field to be formed in the counterclockwise direction of the core. As magnetic fluxes are formed in opposite directions, the magnetic fluxes may cancel each other inside the core.

A detailed description of the coupled inductor will be provided below.

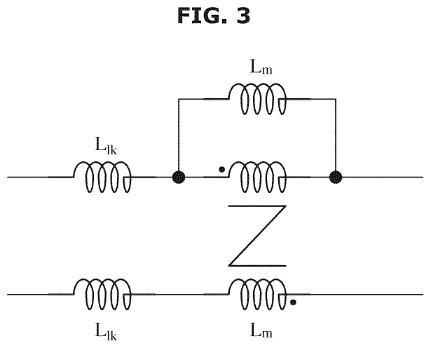

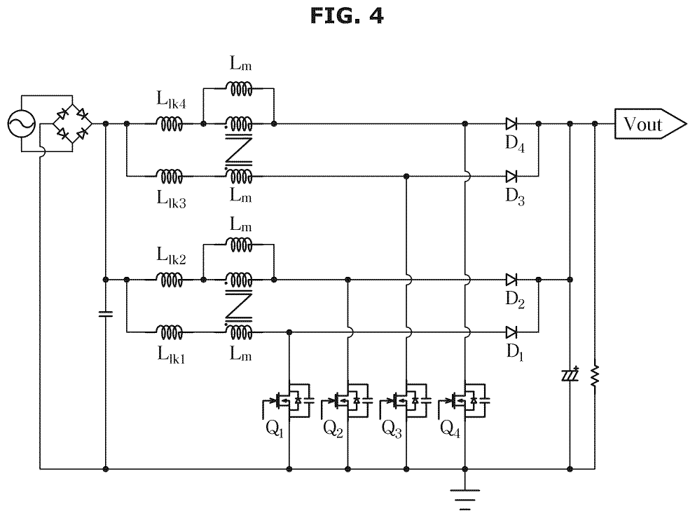

FIG. 3 is a diagram illustrating an equivalent inductance of the coupled inductor according to FIG. 2 according to various embodiments, and FIG. 4 is a circuit diagram illustrating an example structure of a converter circuit including the equivalent inductance of FIG. 3 according to various embodiments.

The equivalent inductance of the coupled inductor shown in FIG. 2 may be illustrated as shown in FIG. 3.

As the two inductors are magnetically coupled, the equivalent inductance may be illustrated as a leakage inductance Lₗₖ and a magnetizing inductance Lₘ.

FIG. 3 illustrates the coupling of the first inductor and the second inductor as the equivalent inductance. When measuring the inductance by shorting numbers 2-4 of each inductor, it can be expressed as L₁₋₃=2Lₖ, and when measuring the inductance by shorting numbers 3-4 of each inductor, it can be expressed as L₁₋₂=2Lₗₖ+4 Lₘ.

The leakage inductance Lₗₖ and magnetizing inductance Lₘ may be calculated according to the above-mentioned measurement.

The equivalent inductance according to the switch operation mode will be described in greater detail below with reference to FIG. 4.

Each inductance in a circuit including one inductor in each of the existing two phases, not the coupled inductor described in the present disclosure, will be referred to as L₋ᵢₙ.

When all switching elements connected to the coupled inductor are turned on, a current flowing in the magnetization inductor Lₘ may be overlapped by the operation of the coupled inductor, and thus the equivalent inductance seen on each phase of the coupled inductor may be expressed as a double component L_{IK}+2 Lₘ of the leakage inductance Lₗₖ and magnetizing inductance Lₘ.

In this case, in order to operate at the same operating frequency as the existing operating frequency, the equivalent inductance Lₗₖ+2 Lₘ of each phase of each coupled inductor may be designed to be 2L₋ᵢₙ.

When a switching element connected to one phase of each phase of the coupled inductor is turned on, a current of the leakage inductor Lₗₖ and a current of the magnetization inductor Lₘ may have the same value, and the equivalent inductance may be expresses as the sum Lₗₖ+Lₘ of the leakage inductance and magnetizing inductance.

As mentioned above, it is designed as Lₗₖ+2 Lₘ=2 L₋ᵢₙ and thus the equivalent inductance Lₗₖ+Lₘ may have a larger value than the existing inductance L₋ᵢₙ, which is Lₗₖ+Lₘ>L₋ᵢₙ. A detailed description of each switching operation mode will be provided below.

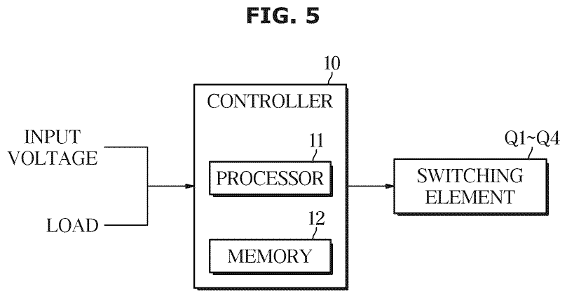

FIG. 5 is a block diagram illustrating an example configuration of the converter circuit according to various embodiments.

The converter circuit may further include a controller 10 configured to control the first to fourth switching elements Q1-Q4. The controller 10 may include at least one processor (e.g., including processing circuitry) 11 and memory 12.

The controller 10 may include the memory 12 configured to store a control program and control data for controlling the switching element, and the processor 11 configured to generate a control signal according to the control program and the control data stored in the memory 12. The memory 12 and the processor 11 may be provided integrally or may be provided separately.

The memory 12 may store programs for controlling the switching elements.

The memory 12 may include volatile memory such as Static Random Access Memory (S-RAM) and Dynamic Random Access Memory (D-RAM) for temporarily storing data. In addition, the memory 12 may include non-volatile memory such as Read Only Memory (ROM), Erasable Programmable Read Only Memory (EPROM), and Electrically Erasable Programmable Read Only Memory (EEPROM) for long-term storage of data.

The processor 11 may include various processing circuitry including various logic circuits and operation circuits. The processor 11 may process data according to a program provided from the memory 12, and generate control signals according to the processing results. The processor 11 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Based on the input voltage and load input to the converter circuit, the at least one processor 11 may turn on at least one switching element among the first to fourth switching elements

Hereinafter a change in the switching operation mode according to the input voltage and load will be described in greater detail.

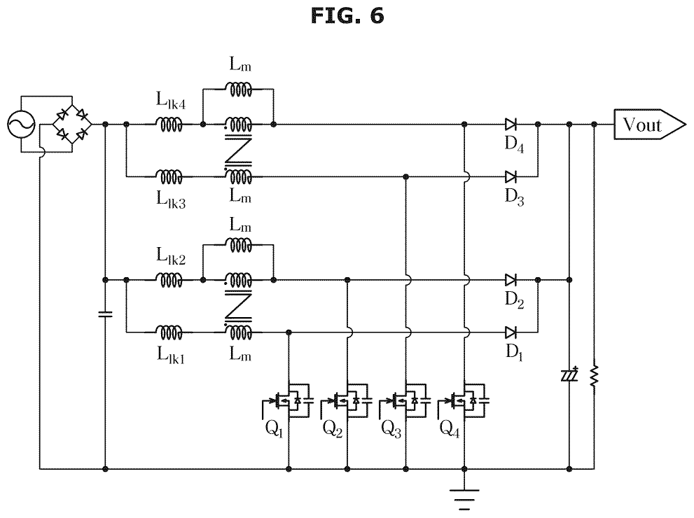

FIG. 6 is a circuit diagram illustrating a state in which all switches are turned on according to various embodiments.

In response to an input voltage being less than a predetermined (e.g., specified) voltage and in response to a load being greater than a predetermined load, the at least one processor 11 may turn on all of the first to fourth switching elements Q1-Q4.

A voltage that is less than the predetermined voltage may refer, for example, to 100V as a low voltage input, and a voltage that is greater than the predetermined voltage may refer, for example, to 240V as a high voltage input.

As described above, the equivalent inductance Lₗₖ+2 Lₘ may be designed to have the same inductance as the inductance 2Lᵢₙ of the existing two-phase converter circuit.

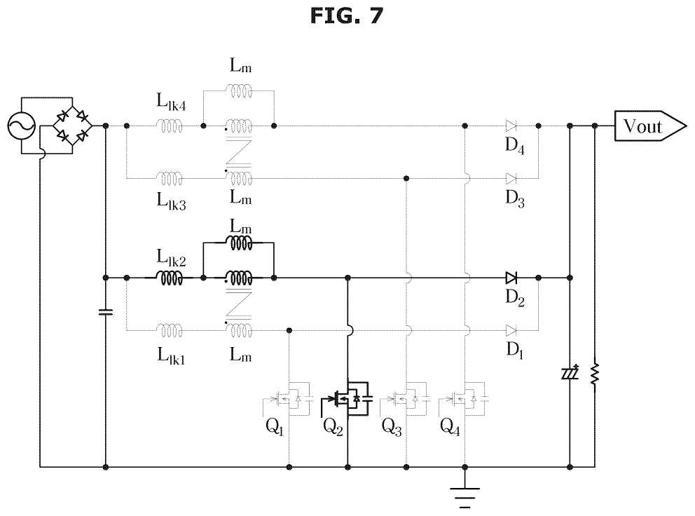

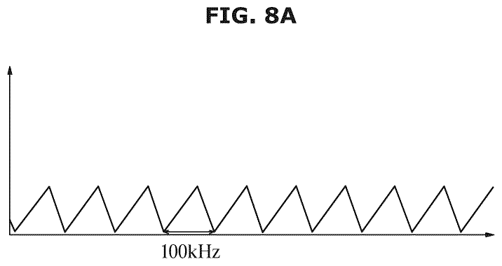

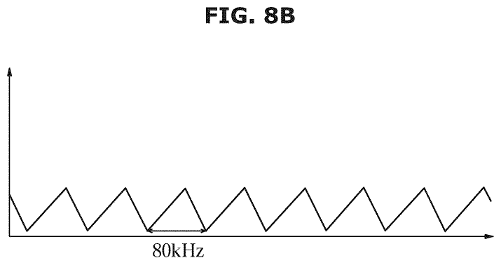

FIG. 7 is a circuit diagram illustrating a state in which one switch is turned on according to various embodiments, and FIGS. 8A and 8B are graphs illustrating the decrease in frequency according to the switching of FIG. 7 according to various embodiments.

In response to the input voltage being less than the predetermined voltage and in response to the load being less than the predetermined load, that is, in a low voltage/light load section, the load is relatively low and thus one of the first to fourth switching elements Q1-Q4 may be turned on.

FIG. 7 illustrates a case in which the second switching element Q2 is turned on, but is not limited thereto. One switching element other than the second switching element Q2 among the first to fourth switching elements Q1-Q4 may be turned on.

Because the load is relatively low, one phase may handle all loads by turning off all switching elements except one switching connected to one phase. As the equivalent inductance Lₗₖ+Lₘ is greater than Lᵢₙ₋, the operating frequency may be reduced.

Referring to FIGS. 8A and 8B, in a conventional manner, it can be seen that the operating frequency is 100 kHz in response to the input voltage being less than the predetermined voltage and in response to the load being less than the predetermined load. However, it can be seen that the operating frequency is reduced to 80 kHz by applying a coupled inductor and by turning on a single switching element by adjusting the operation mode of the switching element.

Accordingly, it is possible to reduce the switching loss of the switch and the core loss of the magnetic element, which are proportional to the operating frequency.

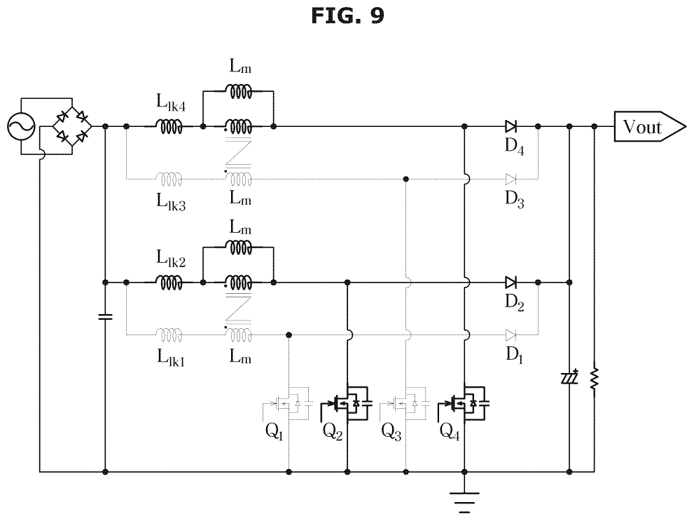

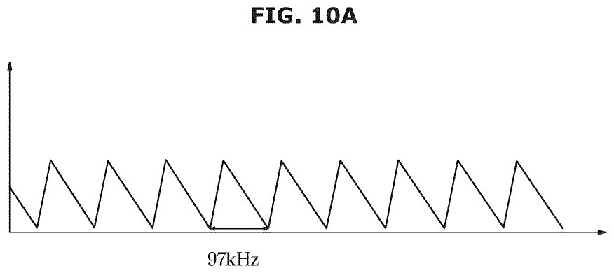

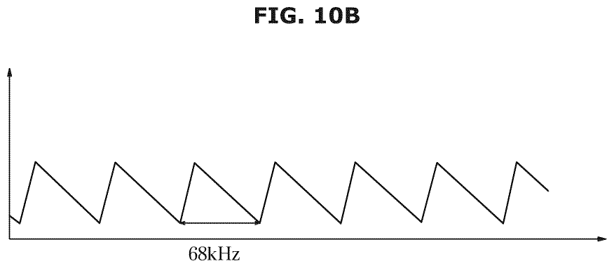

FIG. 9 is a circuit diagram illustrating a state in which two switches are turned on according to various embodiments, and FIGS. 10A and 10B are graphs illustrating the decrease in frequency according to the switching of FIG. 9 according to various embodiments.

In response to the input voltage being greater than the predetermined voltage and in response to the load being greater than the predetermined load, that is, in a high voltage/heavy load section, the load is relatively low compared to the low voltage/heavy load due to the increase in input voltage and thus the current flowing in each switching element and inductor decreases.

Therefore, at this time, one of the first switching element Q1 and the second switching element Q2 may be turned on, and one of the third switching element Q3 and the fourth switching element Q4 may be turned on.

FIG. 9 illustrates a case in which the second switching element Q2 and the fourth switching element Q4 are turned on, but is not limited thereto. The first switching element Q1 of the first and second switching elements may be turned on, and the third switching element Q3 of the third and fourth switching elements may be turned on.

The operating frequency may be reduced as the equivalent inductance Lₗₖ+Lₘ is greater than Lᵢₙ₋.

Referring to FIGS. 10A and 10B, in a conventional manner, it can be seen that the operating frequency is 97 kHz in response to the input voltage being greater than the predetermined voltage and in response to the load being greater than the predetermined load. However, it can be seen that the operating frequency is reduced to 68 kHz by applying a coupled inductor and by turning on a single switching element among switching elements connected to one coupled inductor by adjusting the operation mode of the switching element.

Accordingly, it is possible to reduce the switching loss of the switch and the core loss of the magnetic element, which are proportional to the operating frequency.

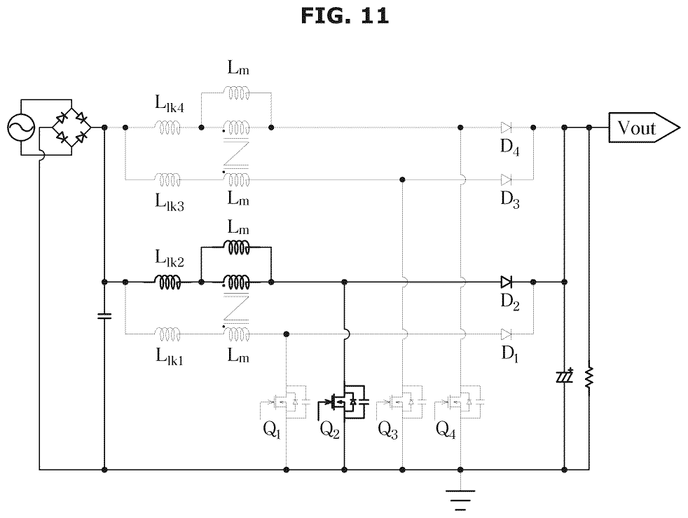

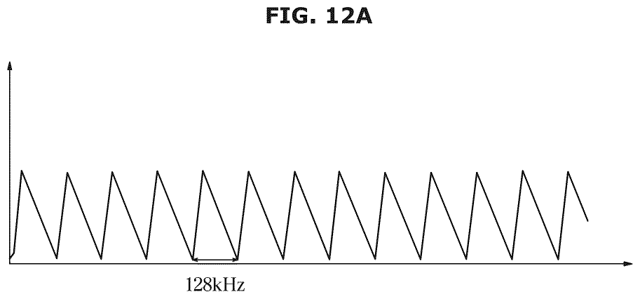

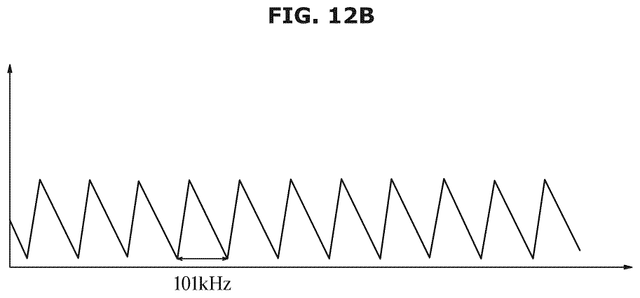

FIG. 11 is a circuit diagram illustrating a state in which one switch is turned on according to various embodiments, and FIGS. 12A and 12B are graphs illustrating the decrease in frequency according to the switching of FIG. 11 according to various embodiments.

In response to the input voltage being greater than the predetermined voltage and in response to the load being less than the predetermined load, that is, in a high voltage/light load section, the load is relatively low and thus one of the first to fourth switching elements Q1-Q4 may be turned on.

FIG. 11 illustrates a case in which the second switching element Q2 is turned on, but is not limited thereto. One switching element other than the second switching element Q2 among the first to fourth switching elements Q1-Q4 may be turned on.

Because the load is relatively low, one phase may handle all loads by turning off all switching elements except one switching connected to one phase. As the equivalent inductance Lₗₖ+Lₘ is greater than Lᵢₙ₋, the operating frequency may be reduced.

Referring to FIGS. 12A and 12B, in a conventional manner, it can be seen that the operating frequency is 128 kHz in response to the input voltage being greater than the predetermined voltage and in response to the load being less than the predetermined load. However, it can be seen that the operating frequency is reduced to 101 kHz by applying a coupled inductor and by turning on a single switching element by adjusting the operation mode of the switching element.

Accordingly, it is possible to reduce the switching loss of the switch and the core loss of the magnetic element, which are proportional to the operating frequency.

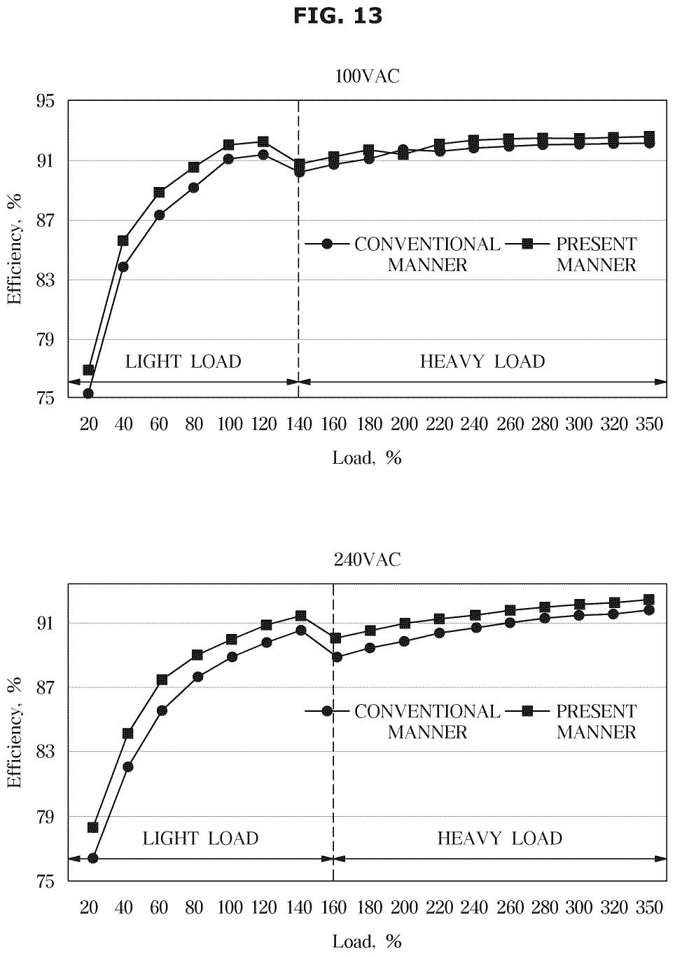

FIG. 13 includes graphs illustrating efficiency according to voltage and load according to various embodiments.

In response to the input voltage being less than the predetermined voltage and in response to the load being less than the predetermined load, that is, in the low voltage/light load section, the load is relatively low and thus one of the first to fourth switching elements Q1-Q4 may be turned on.

Accordingly, as the inductance value increases, the operating frequency decreases, thereby improving an efficiency of about 1.8%.

In response to the input voltage being greater than the predetermined voltage and in response to the load being greater than the predetermined load, that is, in the high voltage/heavy load section, the load is relatively low compared to the low voltage/heavy load due to the increase in input voltage, and thus the current flowing in each switching element and inductor decreases. Therefore, at this time, one of the first and second switching elements may be turned on, and one of the third and fourth switching elements may be turned on.

Accordingly, as the inductance value increases, the operating frequency decreases, thereby improving an efficiency of about 1.4%.

In response to the input voltage being greater than the predetermined voltage and in response to the load being less than the predetermined load, that is, in the high voltage/light load section, the load is relatively low and thus one of the first to fourth switching elements Q1-Q4 may be turned on.

Accordingly, as the inductance value increases, the operating frequency decreases, thereby improving an efficiency of about 2.6%.

By providing the coupled inductor to the converter circuit and by changing the switching operation mode according to the input voltage and load, the inductance increases and the operating frequency decreases accordingly, thereby improving the efficiency.

The coupled inductor may be coupled to allow a polarity of the induced voltage to be the same, or to be opposite.

Hereinbefore the coupled inductor, in which the polarity of the induced voltage is coupled in the same direction, has been described.

Hereinafter a coupled inductor, in which the polarity of the induced voltage is coupled in the opposite direction will be described in greater detail.

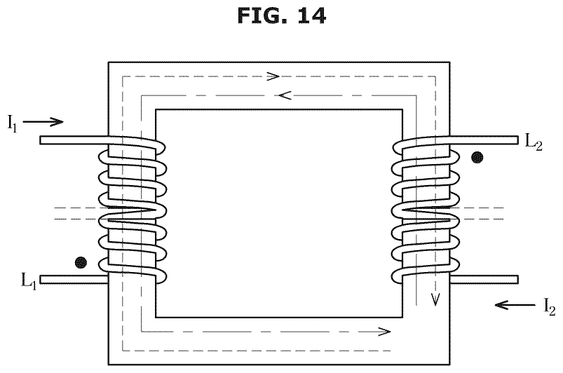

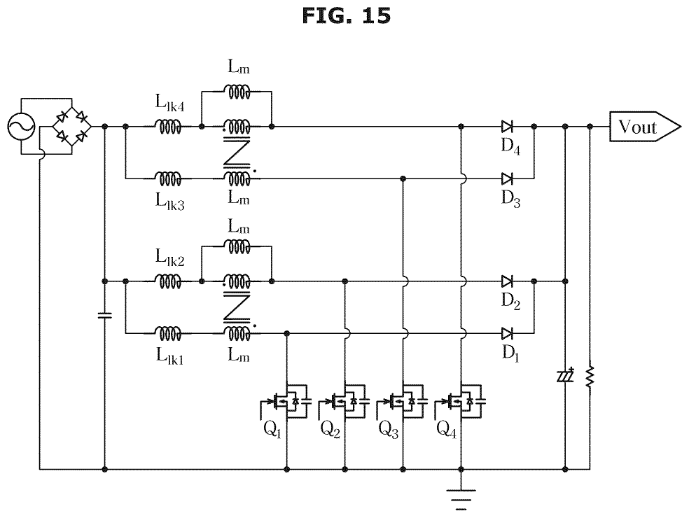

FIG. 14 is a diagram illustrating an example structure of a coupled inductor according to various embodiments, and FIG. 15 is a circuit diagram illustrating an example structure of a converter circuit including an equivalent inductance of the coupled inductor according to FIG. 14 according to various embodiments.

As mentioned above, each inductance in a circuit including one inductor in each of the existing two phases, not the coupled inductor described in the present disclosure, will be referred to as L₋ᵢₙ.

When all switching elements connected to the coupled inductor are turned on, a current flowing in the magnetization inductor Lₘ may be canceled out by the operation of the coupled inductor, and thus the equivalent inductance seen on each phase of the coupled inductor may be expressed as the leakage inductance Lₗₖ component.

In this case, in order to operate at the same operating frequency as the existing operating frequency, the equivalent inductance Lₗₖ of each phase of each coupled inductor may be designed to be 2L₋ᵢₙ.

When a switching element connected to one phase of each phase of the coupled inductor is turned on, a current of the leakage inductor Lₗₖ and a current of the magnetization inductor Lₘ may have the same value, and the equivalent inductance may be expresses as the sum Lₗₖ+Lₘ of the leakage inductance and magnetizing inductance.

As mentioned above, it is designed as Lₗₖ=2 L₋ᵢₙ and thus the equivalent inductance Lₗₖ+Lₘ may have a larger value than the existing inductance L₋ᵢₙ, which is Lₗₖ+Lₘ>L₋ᵢₙ.

Hereinafter switching operation modes according to input voltage and load will be described in greater detail.

In response to the input voltage being less than the predetermined voltage and in response to the load being less than the predetermined load, that is, in the low voltage/light load section, the load is relatively low and thus one of the first to fourth switching elements Q1-Q4 may be turned on.

Because the load is relatively low, one phase may handle all loads by turning off all switching elements except one switching connected to one phase. As the equivalent inductance Lₗₖ+Lₘ is greater than Lᵢₙ₋, the operating frequency may be reduced.

In response to the input voltage being greater than the predetermined voltage and in response to the load being greater than the predetermined load, that is, in the high voltage/heavy load section, the load is relatively low compared to the low voltage/heavy load due to the increase in input voltage, and thus the current flowing in each switching element and inductor decreases.

Therefore, one of the first and second switching elements may be turned on, and one of the third and fourth switching elements may be turned on.

The operating frequency may be reduced as the equivalent inductance Lₗₖ+Lₘ is greater than Lᵢₙ₋.

In response to the input voltage being greater than the predetermined voltage and in response to the load being less than the predetermined load, that is, in the high voltage/light load section, the load is relatively low and thus one of the first to fourth switching elements Q1-Q4 may be turned on.

Because the load is relatively low, one phase may handle all loads by turning off all switching elements except one switching connected to one phase. As the equivalent inductance Lₗₖ+Lₘ is greater than Lᵢₙ₋, the operating frequency may be reduced.

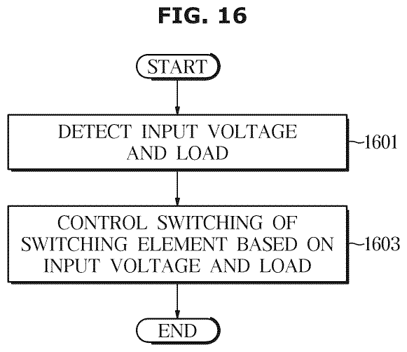

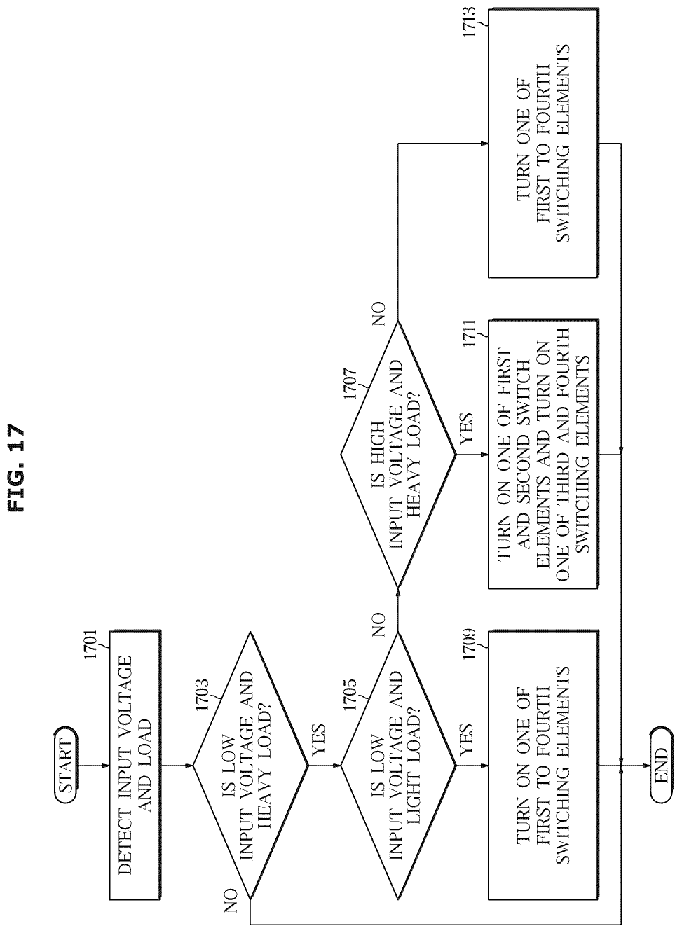

FIGS. 16 and 17 are flowcharts illustrating example methods of controlling a converter circuit according to various embodiments.

The input voltage and load applied to the converter circuit may be detected (1601), and the first to fourth switching elements Q1-Q4 may be controlled based on the detected input voltage and load (1603).

For example, whether the input voltage and load are greater or less than the predetermined value may be determined by detecting the input voltage and load (1701).

In response to the input voltage being less than the predetermined voltage and in response to the load being less than the predetermined load (1703), that is, in the low voltage/light load section (yes in 1705), the load may be relatively low and thus one of the first to fourth switching elements may be turned on (1709).

Because the load is relatively low, one phase may handle all loads by turning off all switching elements except one switching connected to one phase. As the equivalent inductance Lₗₖ+Lₘ is greater than Lᵢₙ₋, the operating frequency may be reduced.

In response to the input voltage being greater than the predetermined voltage and in response to the load being greater than the predetermined load, that is, in the high voltage/heavy load section (yes in 1707), the load is relatively low compared to the low voltage/heavy load due to the increase in input voltage, and thus the current flowing in each switching element and inductor decreases.

Therefore, at this time, one of the first and second switching elements may be turned on, and one of the third and fourth switching elements may be turned on (1711).

The operating frequency may be reduced as the equivalent inductance Lₗₖ+Lₘ is greater than Lᵢₙ₋.

In response to the input voltage being greater than the predetermined voltage and in response to the load being less than the predetermined load, that is, in the high voltage/light load section (no in 1707), the load is relatively low and thus one of the first to fourth switching elements may be turned on (1713).

Because the load is relatively low, one phase may handle all loads by turning off all switching elements except one switching connected to one phase. As the equivalent inductance Lₗₖ+Lₘ is greater than Lᵢₙ₋, the operating frequency may be reduced.

As is apparent from the above description, a coupled inductor is applied to each phase inductor of an interleaved converter, and switch operation modes are divided according to an input voltage and a load, and thus when the input voltage is increased or the load is reduced, an operating frequency may be reduced by increasing an inductance value of the inductor. Accordingly, the efficiency may be improved

The various example embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which can be decoded by a computer are stored. For example, there may be a Read Only Memory (ROM), a Random Access Memory (RAM), a magnetic tape, a magnetic disk, a flash memory, and an optical data storage device.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) describe herein may be used in conjunction with any other embodiments(s) described herein.

What is claimed is:

1. A converter circuit comprising:
first, second, third and fourth inductors connected in parallel to each other;
first, second, third and fourth switching elements comprising at least one switch connected to the first, second, third and fourth inductors respectively; and
at least one processor, comprising processing circuitry, individually and/or collectively, configured to control the first, second, third and fourth switching elements,
wherein the first inductor and the second inductor are coupled to each other, and the third inductor and fourth inductor are coupled each other.

2. The converter circuit of claim 1, wherein
at least one processor, individually and/or collectively, is configured to turn on at least one switching element among the first, second, third and fourth switching elements based on an input voltage and a load.

3. The converter circuit of claim 2, wherein
at least one processor, individually and/or collectively, is configured to turn on one switching element among the first to fourth switching elements in response to the input voltage being less than a specified voltage and in response to the load being less than a specified load.

4. The converter circuit of claim 2, wherein
at least one processor, individually and/or collectively, is configured to turn on one of the first and second switching elements and configured to turn on one of the third and fourth switching elements in response to the input voltage being greater than the specified voltage and in response to the load being greater than the specified load.

5. The converter circuit of claim 2, wherein
at least one processor, individually and/or collectively, is configured to turn on one switching element among the first, second, third and fourth switching elements in response to the input voltage being greater than the specified voltage and in response to the load being less than the specified load.

6. The converter circuit of claim 1, wherein
the coupled inductor includes at least one of a UU core inductor, an EE core inductor, or an EI core inductor.

7. The converter circuit of claim 1, wherein
the first, second, third and fourth switching elements include transistors,
wherein gate voltages output from the first switching element and the second switching element have opposite phases to each other,
wherein gate voltages output from the third and fourth switching elements have opposite phases to each other.

8. The converter circuit of claim 1, further comprising:
first, second, third and fourth diodes connected in series with the first, second, third and fourth inductors, respectively,
wherein the first diode, the second diode, the third diode, and the fourth diode are each integrated into one package.

9. The converter circuit of claim 1, wherein
the coupled inductor is coupled and configured to allow a polarity of an induced voltage to be the same or to be opposite.

10. The converter circuit of claim 1, wherein
the coupled inductor is configured to allow each current to flow in a direction in which a magnetic flux is canceled out.

11. A method of controlling a converter circuit comprising first, second, third and fourth inductors connected in parallel to each other; and first, second, third and fourth switching elements comprising at least one switch connected to the first, second, third and fourth inductors respectively, the method comprising:
detecting an input voltage and a load; and
controlling the first, second, third and fourth switching elements based on the detected input voltage and load,
wherein the first inductor and the second inductors are coupled to each other, and the third inductor and fourth inductor are coupled each other.

12. The method of claim 11, wherein
the controlling of the first, second, third and fourth switching elements comprises turning on at least one switching element among the first, second, third and fourth switching elements based on the detected input voltage and load.

13. The method of claim 12, wherein
the controlling of the first, second, third and fourth switching elements comprises turning on one switching element among the first, second, third and fourth switching elements in response to the input voltage being less than a specified voltage and in response to the load being less than a specified load.

14. The method of claim 12, wherein
the controlling of the first, second, third and fourth switching elements comprises turning on one of the first and second switching elements and turning on one of the third and fourth switching elements in response to the input voltage being greater than the specified voltage and in response to the load being greater than the specified load.

15. The method of claim 12, wherein
the controlling of the first, second, third and fourth switching elements comprises turning on one switching element among the first, second, third and fourth switching elements in response to the input voltage being greater than the specified voltage and in response to the load being less than the specified load.
